(19) United States
(12) Patent Application Publication
(10) Pub. No.: US 2019/0354880 A1
(43) Pub. Date: Nov. 21, 2019

(54) GOAL-BASED IMPLEMENTATIONS PLANS FOR COMPLEX SYSTEM DETERMINED USING MULTI-DIMENSIONAL KNOWLEDGE GRAPHS

(71) Applicant: Accenture Global Solutions Limited, Dublin (IE)

(72) Inventors: Freddy Lecue, Dublin (IE); Christophe Dominique Marie Gueret, Dublin (IE)

(21) Appl. No.: 16/130,357

(22) Filed: Sep. 13, 2018

Related U.S. Application Data
(60) Provisional application No. 62/673,384, filed on May 18, 2018.

(51) Int. Cl. G06N 5/02; G06F 17/30; B09C 1/10; B64C 39/02; B63B 22/00

(52) U.S. Cl. CPC G06N 5/025; G06F 17/30958; B09C 1/105; B63B 2022/006; B63B 22/00; B64C 2201/12; B64C 39/024

(57) ABSTRACT

Methods, systems, and apparatus, including computer programs encoded on a computer storage medium, for to enabling an action to accomplish a goal for a complex system. In one aspect, a method includes applying a slicing policy to an area within the complex system; receiving sensor data from a plurality of sensor devices positioned to collect readings from the complex system; extracting a knowledge graph based on the respective sensor data; extracting a macro knowledge graph based on a relationship between grid sections; merging the macro knowledge graph with a domain knowledge graph and an actions knowledge graph to form a recommendation knowledge graph; identifying an implementation plan for accomplishing a set goal for the complex system based on an analysis of the recommendation knowledge graph, the implementation plan including actions to accomplish a set goal; and enabling an implementation of at least one of the actions in the implementation plan.

### CROSS-REFERENCE TO RELATED APPLICATION

The present disclosure is related to, and claims priority to, U.S. Provisional Patent Application No. 62/673,384, titled “Soil Decontamination Using Multi-Dimensional Knowledge Graphs,” which was filed on May 18, 2018, the entirety of which is incorporated by reference into the present disclosure.

### BACKGROUND

A complex system includes many components that interact with each other. The behavior of complex systems is intrinsically difficult to model due to the dependencies, relationships, or other types of interactions between the various parts of the system and/or between the system and its environment. Complex systems have distinct properties that arise from these relationships, such as nonlinearity, emergence, spontaneous order, adaptation, feedback loops, and so forth. Examples of complex systems includes global climate, organisms, social and economic organizations, ecosystems, and cells.

### SUMMARY

Implementations of the present disclosure are generally directed to accomplish a goal for a complex system. More particularly, implementations of the present disclosure are directed to creating a knowledge graph from data collected by sensor devices deployed to an area in and around a complex system. The knowledge graph can be employed to determine actions to accomplish a goal(s) within the complex system. An example context of a goal of decontaminating the soil in the complex system of a peat bog is referenced throughout this disclosure; however, the described assessment system can be employed within any complex system to enable actions toward the accomplishment of a set goal within the complex system.

In a general implementation, a system includes one or more processors and a computer-readable storage device coupled to the one or more processors. Instructions are stored on the computer-readable storage device that when executed by the one or more processors, cause the one or more processors to perform operations. These operations include applying a slicing policy to an area within the complex system to divide the area based on an ordered grid, the ordered grid including a plurality of grid sections. The sensor data is received from a plurality of sensor devices positioned to collect readings from the complex system. A knowledge graph is extracted for each of the grid sections based on the respective sensor data for each of the grid sections. A macro knowledge graph is extracted by linking the knowledge graph for each of the grid sections based on a relationship between each of the grid sections. The macro knowledge graph mapping elements of the complex system and causal relationships between the elements to represent a state of the complex system. The macro knowledge graph is merged with a domain knowledge graph and an actions knowledge graph to form a recommendation knowledge graph. The domain knowledge graph maps relevant expertise for the set goal in the complex system. The actions knowledge graph maps steps to achieve the set goal. An implementation plan is identified for accomplishing the set goal for the complex system based on an analysis of the recommendation knowledge graph, the implementation plan including actions to accomplish the set goal for the complex system. An implementation of at least one of the actions in the implementation plan is enabled.

In another general implementation, one or more non-transitory computer-readable storage media coupled to one or more processors and having instructions stored thereon which, when executed by the one or more processors, cause the one or more processors to perform operations that include: applying a slicing policy to an area within the complex system to divide the area based on an ordered grid, the ordered grid including a plurality of grid sections. The sensor data is received from a plurality of sensor devices positioned to collect readings from the complex system. A knowledge graph is extracted for each of the grid sections based on the respective sensor data for each of the grid sections. A macro knowledge graph is extracted by linking the knowledge graph for each of the grid sections based on a relationship between each of the grid sections. The macro knowledge graph mapping elements of the complex system and causal relationships between the elements to represent a state of the complex system. The macro knowledge graph is merged with a domain knowledge graph and an actions knowledge graph to form a recommendation knowledge graph. The domain knowledge graph maps relevant expertise for the set goal in the complex system. The actions knowledge graph maps steps to achieve the set goal. An implementation plan is identified for accomplishing the set goal for the complex system based on an analysis of the recommendation knowledge graph, the implementation plan including actions to accomplish the set goal for the complex system. An implementation of at least one of the actions in the implementation plan is enabled.

In yet another general implementation, a system includes one or more processors; and a computer-readable storage device coupled to the one or more processors and having instructions stored thereon which, when executed by the one or more processors, cause the one or more processors to perform operations comprising: applying a slicing policy to an area within the complex system to divide the area based on an ordered grid, the ordered grid including a plurality of grid sections. The sensor data is received from a plurality of sensor devices positioned to collect readings from the complex system. A knowledge graph is extracted for each of the grid sections based on the respective sensor data for each of the grid sections. A macro knowledge graph is extracted by linking the knowledge graph for each of the grid sections based on a relationship between each of the grid sections. The macro knowledge graph mapping elements of the complex system and causal relationships between the elements to represent a state of the complex system. The macro knowledge graph is merged with a domain knowledge graph and an actions knowledge graph to form a recommendation knowledge graph. The domain knowledge graph maps relevant expertise for the set goal in the complex system. The actions knowledge graph maps steps to achieve the set goal. An implementation plan is identified for accomplishing the set goal for the complex system based on an analysis of the recommendation knowledge graph, the implementation plan including actions to accomplish the set goal for the complex system. An implementation of at least one of the actions in the implementation plan is enabled.

An aspect combinable with the general implementations, the sensor data includes exogenous data regarding conditions occurring in and around the complex system.

In an aspect combinable with any of the previous aspects, at least one of the sensor devices is included as a payload or component of an unmanned aerial vehicle (UAVs) or a buoy deployed to an area around the complex system.

In an aspect combinable with any of the previous aspects, the recommendation knowledge graph is formed by adding one or more nodes to the macro knowledge graph, a location of the one or more nodes being based on the domain knowledge graph.

In an aspect combinable with any of the previous aspects, the sensor data includes ambient air temperature data or ambient air pressure data.

In an aspect combinable with any of the previous aspects, the complex system is a peat bog and wherein the set goal is decontaminating soil content in an area within the peat bog.

In an aspect combinable with any of the previous aspects, the sensor data includes information regarding soil and water content of the area within the peat bog.

In an aspect combinable with any of the previous aspects, decontaminating the soil content includes reducing an amount of a chemical compound in the soil.

In an aspect combinable with any of the previous aspects, the actions include placement of a mirror in a location in the peat bog to increase sunlight to the area within the peat bog.

In an aspect combinable with any of the previous aspects, the actions include placement a plant in a location in the peat bog to mitigate toxicity levels of the chemical compound.

The described assessment system can be implemented to capture the state of a complex system in its entirety based on the elements within the complex system and the relationships between them, which is represented through a knowledge graph. The described assessment system provides for more holistic options to accomplish a set goal for the complex system. Moreover, the described assessment system may be employed to capture a snapshot of a multi-dimensional view of the complex system trough, for example, a uniformed knowledge graph.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example environment that can be employed to execute implementations of the present disclosure.

FIGS. 2A-2B depict an example process employed in an assessment system.

FIG. 3 depicts a flow diagram of an example process that can be executed in implementations of the present disclosure.

FIG. 4 depicts an example knowledge graph generated for an area based on collected sensor data.

FIG. 5 depicts a flow diagram of another example process that can be executed in implementations of the present disclosure.

FIG. 6 depicts an example of a computing device and a mobile computing device that can be employed in implementations of the present disclosure.

### DETAILED DESCRIPTION

This disclosure generally describes an adaptive assessment system and is presented to enable any person skilled in the art to make and use the disclosed subject matter in the context of one or more particular implementations. Various modifications to the disclosed implementations will be readily apparent to those skilled in the art, and the general principles defined in this application may be applied to other implementations and applications without departing from the scope of the disclosure. Thus, the present disclosure is not intended to be limited to the described or illustrated implementations, but is to be accorded the widest scope consistent with the principles and features disclosed in this application.

The described assessment system may be employed to assess the state of a complex system though the construction and use of multi-dimensional knowledge graphs. For example, data, such as environmental data, may be collected from a complex system through various sensor devices that are strategically placed to monitor the complex system. A knowledge graph (also known as a knowledge map) may be constructed based on the collected data. The extracted knowledge graph encapsulated the state of the complex system and is based on identified elements (e.g., nodes) and relationships between each of the elements. For example, a knowledge graph maps elements such that the causal relationships between the elements can be assessed. These elements may have differing scales or units of measure but are still related through the relationships reflected in the knowledge graph. As such, the relationships between elements in a knowledge graph are provided in much more detail than models build through, for example, a relational database.

In the described assessment system, an extracted knowledge graph may be used to assess the state of the monitored complex system and to generate an implementations plan to accomplish a goal within in the monitored system. In some implementations, the knowledge graph extracted from sensor data collected from a complex system is merged with other knowledge graphs. For example, the extracted knowledge graph may be merged with a knowledge graph mapping expertise in the areas related to the complex system and/or the goal(s) for the system (e.g., a domain knowledge graph). As another example, the extracted knowledge graph may be merged with a knowledge graph mapping recommendations to accomplish the goal within the monitored complex system (e.g., an actions knowledge graph). A merged graph may be employed to make holistic decisions in the determination of an implementations plan to accomplish the established goal for the respective complex system.

In some implementations, a knowledge graph is a collection of data that is related based on a schema that represents entities and relationships between entities. Within a knowledge graph, data can be logically described as a graph (even though it may also be provided in table), in which each distinct entity is represented by a respective node, and each relationship between pairs of entities is represented by an edge between the nodes. In some implementations, each edge is associated with a relationship and the existence of the edge represents that the associated relationship exists between the nodes connected by the edge. For example, if a node A represents a person Alpha, a node B represents a person Beta, and an edge E is associated with the relationship “is the father of,” then having the edge E connect the nodes in the direction from node A to node B in the graph represents the fact that Alpha is the father of Beta. In some examples, the knowledge graph can be enlarged with schema-related knowledge (e.g., Alpha is an instance of the concept Person, Beta is an instance of the concept Person, and “is the father of” is a property or relationship between two entities/instances of concept Person). Adding schema-related information supports the materialization and evaluation of reasoning results.

A knowledge graph can be represented by any of a variety of physical data structures. For example, a knowledge graph can be represented by triples that each represent two entities in a specific order. Such triples may also represent a relationship from the first to the second entity. For example, [Alpha, Beta, is the father of], or [Alpha, is the father of, Beta], are alternative ways of representing the same fact. Each entity and each relationship can be, and generally will be, included in multiple triples.

In some examples, each entity can be stored as a node once, as a record or an object, for example, and linked through a linked list data structure to all the relationships the entity has, and all the other entities to which the entity is related. More specifically, a knowledge graph can be stored as an adjacency list in which the adjacency information includes relationship information. In some examples, each distinct entity and each distinct relationship are represented with respective, unique identifiers.

The entities represented by a knowledge graph need not be tangible things or specific people. The entities can include particular people, places, things, artistic works, concepts, events, or other types of entities. Thus, a knowledge graph can include data defining relationships between people (e.g., co-stars in a movie); data defining relationships between people and things (e.g., a particular singer recorded a particular song); data defining relationships between things and places (e.g., a particular type of wine comes from a particular geographic location); data defining relationships between people and places (e.g., a particular person was born in a particular city); and other kinds of relationships between entities.

In some implementations, each node within a knowledge graph has a type that may be based on the kind of entity the node represents. These types can each have a schema specifying the kinds of data that can be maintained about entities represented by nodes of the type and how the data should be stored. For example, a node of a type representing a person could have a schema defining fields for information such as birth date, birthplace, and so on. Such information can be represented by fields in a type-specific data structure, or by triples that look like node-relationship-node triples (e.g., [person identifier, was born on, date]), or in any other convenient predefined way. In some examples, some or all of the information specified by a type schema can be represented by links to nodes in the knowledge graph, for example, [one person identifier, child of, another person identifier], where the other person identifier is a node in the graph.

The disclosure presents an example complex system of a peat bog to describe the various feature of the described assessment system. However, the described assessment system may be employed to monitor any complex system and to generate an implementation plan to accomplish an established goal within the monitored complex system. Other example complex systems that can employ the described assessment system include land use for livestock, horticulture, and smart cities.

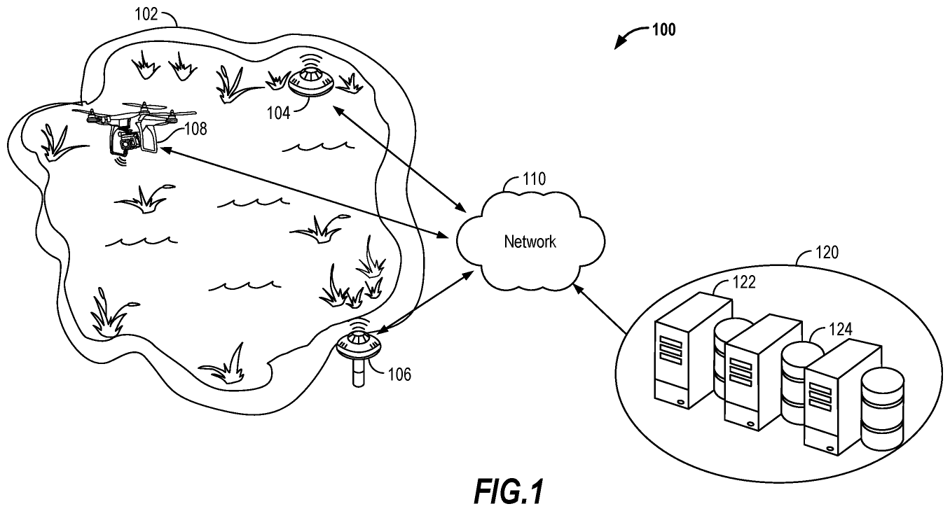

FIG. 1 depicts an example environment 100 that can be employed to execute implementations of the present disclosure. The example environment 100 includes sensor devices 104, 106 and 108 deployed within a peat bog 102, a back-end system 120, and a network 110. In some implementations, the network 110 includes a local area network (LAN), wide area network (WAN), the Internet, or a combination thereof, and connects web sites, devices (e.g., the sensor devices 104, 106, 108) and back-end systems (e.g., the back-end system 120). In some implementations, the network 110 can be accessed over a wired and/or a wireless communications link. For example, sensor devices 104, 106, and 108, can use a cellular network to access the network 110.

Peat bog 102 is provided as an example complex system. Peat bog 102 is a wetland that accumulates peat, which is a deposit of dead plant material and moss. As depicted, the peat bog may be covered in ericaceous shrubs rooted in the peat and moss.

The sensor devices 104, 106, and 108 may each include any appropriate type of sensor device or actuator to collect data regarding the soil and/or water in and around the deployed area, such as the bog 102. These sensors devices may test for soil, water, and/or air properties, such as the number of particles of a contaminant, water content, toxicity, bacteria and other microorganisms, and so forth. In some implementations, the sensor devices 104, 106, and 108 may also collect exogenous data regarding conditions occurring in and around the deployed area, such as weather data. The sensors devices 104, 106, and 108 may be included within or deployed by various delivery vehicles. In the depicted example, the sensor device 104 is provided as a floatation-based sensor device, the sensor device 106 is provided as a land-based sensor device, and the sensor device 108 is provided as an air-based sensor device. For example, sensor device 104 may be deployed by staking it into to ground around the peat bog 102, sensor device 106 may be deployed within a buoy that is designed to float on the surface of the water, and sensor device 108 may be included as a payload or component of an unmanned aerial vehicle (UAV) deployed to monitor the peat bog 102. Other types of sensor devices and deployment mechanisms may also be employed to collect data from a complex system.

Sensor devices 104, 106, and 108 collect and transmit data regarding the monitored area (e.g., the peat bog 102) to, for example, a service provided by the back-end system 120. The collected information can include data related to weather conditions in and around the monitored area (e.g., barometric pressure, temperature, precipitation); water flow in the area and/or from a water pipe or drain; potential Hydrogen (pH), pollutant, and toxicity levels in the soil and/or water; gas content, such as CO₂, levels in the soil and/or the surrounding area (e.g., through air reading); imaging data (e.g., visible light, infrared, ultraviolet); and so forth. The collected information may also include metadata, such as location information (e.g., latitude and longitude coordinates, city, province), size of the monitored area or a portion of the monitored area, timestamp data, and measured units (e.g., parts per million). The collected data may be combined with information regarding a slicing policy for the monitored area 102. In some implementations, the slicing policy divides the monitored area into smaller subsections, which are used to group collected data and implement determined actions. For example, a slicing policing may divide the monitored area into two-meter square sections to form a grid.

In the depicted example, the back-end system 120 includes at least one server system 122 and a data store 124. In some implementations, the at least one server system 122 hosts one or more computer-implemented services that sensor devices 104, 106, and 108 can interact with to, for example, send and receive data. In some implementations, the sensor devices 104, 106, and 108 may collect data regarding the soil or peat condition from a bog 102, which is then sent through the network 110 to a service that is hosted on the at least one server system 122. In some implementations, back-end system 108 includes computer systems using clustered computers and components to act as a single pool of seamless resources when accessed through the network 110. For example, such implementations may be used in data center, cloud computing, storage area network (SAN), and network attached storage (NAS) applications. In some implementations, back-end system 108 is deployed using a virtual machine(s).

In some implementations, the back-end system 120 hosts the described assessment system. The back-end system 120 may receive information collected by the sensor devices 104, 106, and 108 regarding, for example, soil condition of the peat bog 102. The hosted assessment system may process the received data to extract a knowledge graph reflecting the state of the peat bog 102 (the complex system). The hosted assessment system may then determine an implementation plan that enables actions toward the accomplishment of an established goal, such as soil decontamination, within the peat bog 102.

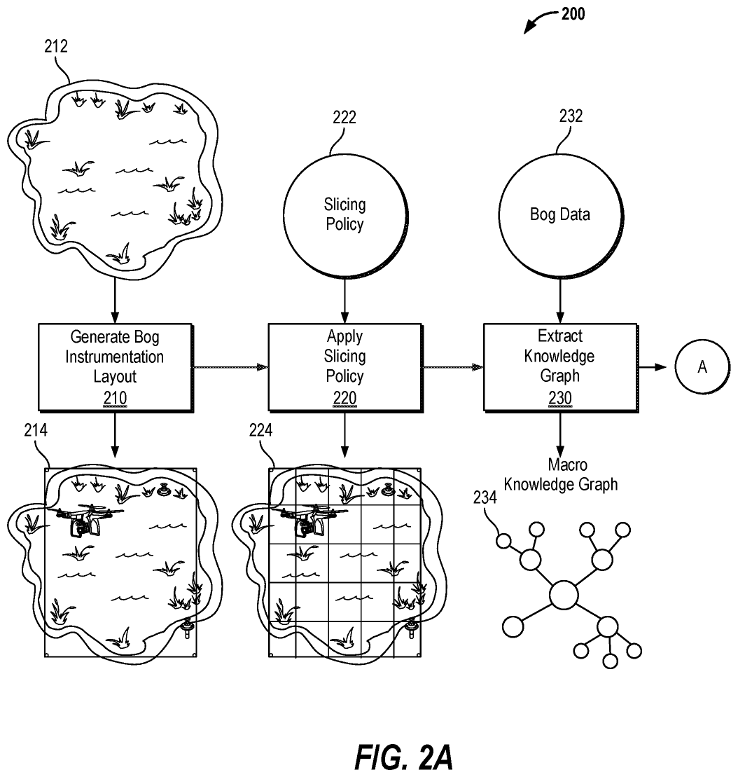

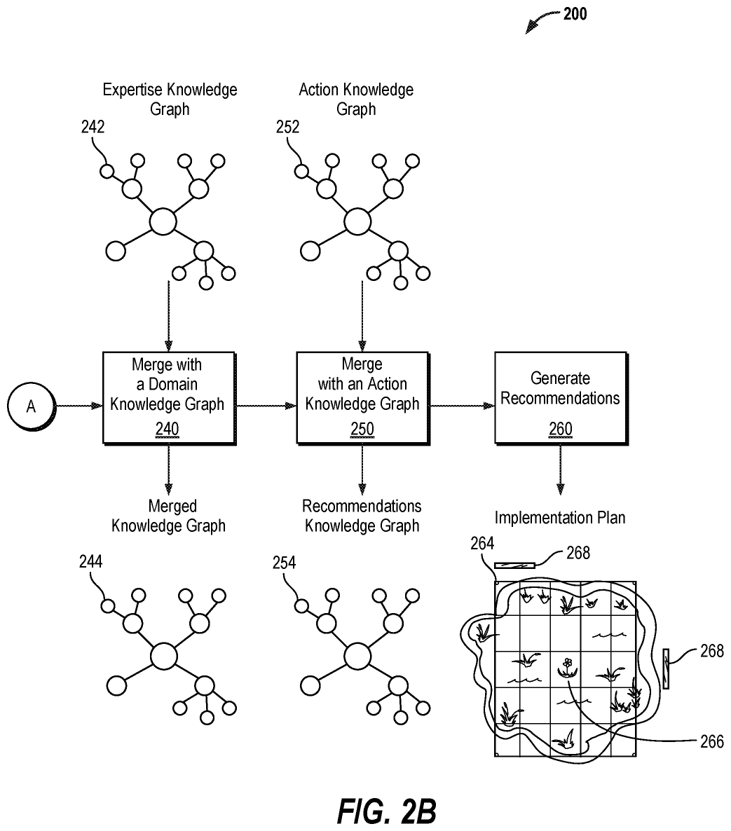

FIGS. 2A-2B depict an example process 200 employed in an assessment system. The example context provided in the description of FIG. 2 is for soil decontamination of a peat bog; however, information can be collected from any complex system and used by the described assessment system to extract a knowledge graph of the state of the respective complex system to enable the implementation of actions to accomplish a goal for the respective complex system. The example system 200 may be provided using one or more computing device(s) of any suitable number and type of computing device, such as depicted in FIG. 1. Configuration of such computing devices include shared, virtual, managed/dedicated, cluster/grid, cloud-based resources, and/or any combination thereof.

A “healthy” bog, as part of its natural process, will release ammonia into the soil. This ammonia may end up in river waters, which could be considered as pollution as accounted against the owner of the bogs. Moreover, within the example context of the peat bog, contamination is an intrinsic property of the soil. Contaminated soils can be identify by chemical testing. Soil contamination may include both solid and liquid hazardous substances mixed with naturally occurring soil. Soil contaminants can be physically or chemically attached to soil particles or trapped in the small spaces between soil particles. For example, some soils contain a large amount of chemical compounds such as lead, arsenic, and/or ammonia. Soil contaminants can harm plants growing in the contaminated soil as they take up the contamination through root systems. These contaminants can also adversely impact the health of animals, such as humans, when they ingest, inhale, and/or touch contaminated soil, or when they eat plants and/or animals that have been affected by the contaminated soil.

At 210, the instrumentation layout 214 of a monitored complex system (e.g., a peat bog) is generated based on, for example, survey data 212 of the area in and around the respective complex system. In some implementations, the instrumentation layout provides placement locations for markers (e.g., in the corners) to note the boundaries of the monitored area. The instrumentation layout 212 may also provide placement locations for the sensor devices, such as sensor devices 104, 106, and 108 from FIG. 1, into the monitored area.

At 220, a slicing policy 222 for the monitored area is applied to the monitored area. In some implementations, the slicing policy is employed to divide the area from which the data is collected into sections. For example, the slicing policy 220 may divide the area in to an ordered grid 224.

At 230, a knowledge graph 234 for the state of the peat bog is extracted based on the data regarding the peat bog (bog data) 232 that is received from the sensor devices. The collected bog data 232 may include information, such as water flow data, exogenous data (e.g., environmental, weather data), and soil content (e.g., contaminants level/amount).

The depicted example output generates a macro knowledge graph 234 from the received inputs. In some implementations, a knowledge graph is extracted for each of the grid sections that is determined according to the slicing policing, where each of the extracted knowledge graphs include data specific to a respective grid section. The generation of the knowledge graphs may include gathering the information for each grid section based on, for example, the location data included in metadata. Once a knowledge graph is generated for each grid section, the sections can be linked to form a macro knowledge graph 234 for the monitored area. In some implementations, the macro knowledge graph 234 is formed using the generated bog knowledge graph for each grid section. In such implementations, the generated macro knowledge graph 234 may link each of the grid sections based on the relationship between each grid section.

At 240, a domain knowledge graph 242 that includes relevant expertise in the respective complex system and/or for the set goal is merged with the knowledge graph 234 to form a merged knowledge graph 244. The domain knowledge graph may incorporate rules (e.g., business rule or general information regarding the complex system and/or set goal(s) for the complex system). In some implementations, the domain knowledge graph 242 is extracted from the collected information in a particular field or by experts (e.g., botanists or hydroponics databanks). For example, in the context of detoxification of a peat bog, the domain knowledge graph 242 may include information regarding toxicity and the various containments that may be in the soil. As described above, such information may be related to, for example, toxicity/pollutant level for a particular containment and/or harmful pH levels.

At 250, a recommendation knowledge graph 254 is generated by merging the merged knowledge graph 244 with an action knowledge graph 252. The actions knowledge graph 252 includes, for example, steps or solutions to specific issues to achieve the goal for the respective complex system.

At 260, the recommendation knowledge graph 254 is analyzed by the assessment system to determine an implementation plan 264 to achieve the goal for the monitored complex system. For example, the implementation plan 264 may include actions such as adding solar panels, adding mirrors 268 to increase light (e.g., to aid in photosynthesis) at particular locations and positioned in a particular direction, adding plants 266 in a particular grid section to mitigate toxicity levels, adding delimitation markers, and so forth.

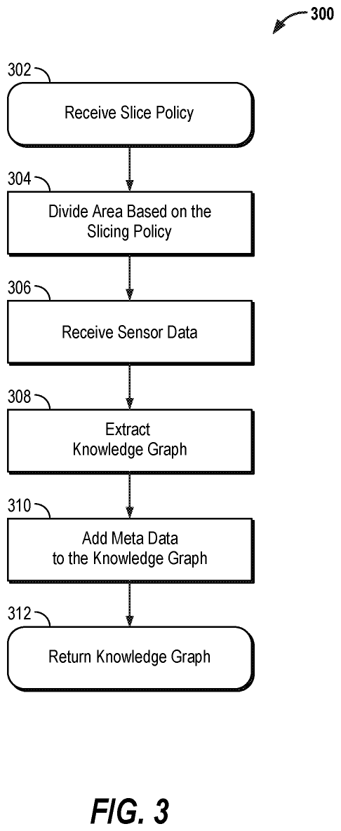

FIG. 3 depicts a flow diagram of an example process 300 to generate a knowledge graph based on collected sensor data, such as bog data for FIG. 2A, that can be executed in implementations of the present disclosure. In some examples, the example process 300 is provided using one or more computer-executable programs executed by one or more computing devices (e.g., the back-end system 108 of FIG. 1). The example process 300 can be executed by an assessment system to provide knowledge graph extracted from data received from sensor devices positioned to collect information regarding a complex system.

At 302, a slicing policy is received. In some implementations, the slicing policy defines the way that the area in and around the monitored complex system is to be divided. From 302, the process 300 proceeds to 304.

At 304, the monitored area for the complex system is divided according to the slicing policy. For example, the slicing policy may divide the area into a grid of sections. In some implementations, each section has the same dimensions. In other implementations, the sections are not uniform, but rather divided according to, for example, the terrane. From 304, the process proceeds to 306.

At 306, data is received from sensor devices, such as sensor devices 104, 106, and 108 from FIG. 1. The data may include information regarding the soil and water in and around the monitored area as well as exogenous data regarding conditions occurring in and around the deployed area, such as weather data. The data may also include metadata, such as timestamps and location information. From 306, the process 300 proceeds to 308.

At 308, a knowledge graph is extracted from the received sensor data. In some implementations, the knowledge graph is extracted for each of the grid sections determined according to the slicing policing, where each of the created knowledge maps include data specific to a respective grid section. Once a knowledge graphs is generated for each grid section, the sections can be linked to form a macro knowledge graph for the monitored area. In some implementations, the macro knowledge graph is formed using the domain knowledge graph and the generated bog knowledge graph for each grid section. In such implementations, the generated macro knowledge graph may link each of the grid sections based on the relationship between each grid section. In some implementations, the grid sections are grouped/connected according to, for example, row and column within the extracted macro knowledge graph. This multi-dimensional data an important aspect to having different views over a given data set. Statically agencies in particular are fond of this information as they may not be able to re-shape the data for every single use case. The described system provides for a one-size-fits-all knowledge graph that could inform several data processing systems. From 308, the process 300 proceeds to 310.

At 310, the metadata is added to the extracted macro knowledge graph for the monitored complex system. For example, some additional contextual data is merged into the graph, such as the geolocation of the bog, the time and date or the reference of the system generating the graph. This information may be added either directly into the graph or as annotation using the standard of “Named graphs.” This extra information can also be considered as provenance data helping for traceability. From 310, the process 300 proceeds to 312.

At 312, the extracted knowledge graph for the monitored complex system is returned for analysis. From 312, the process 300 ends.

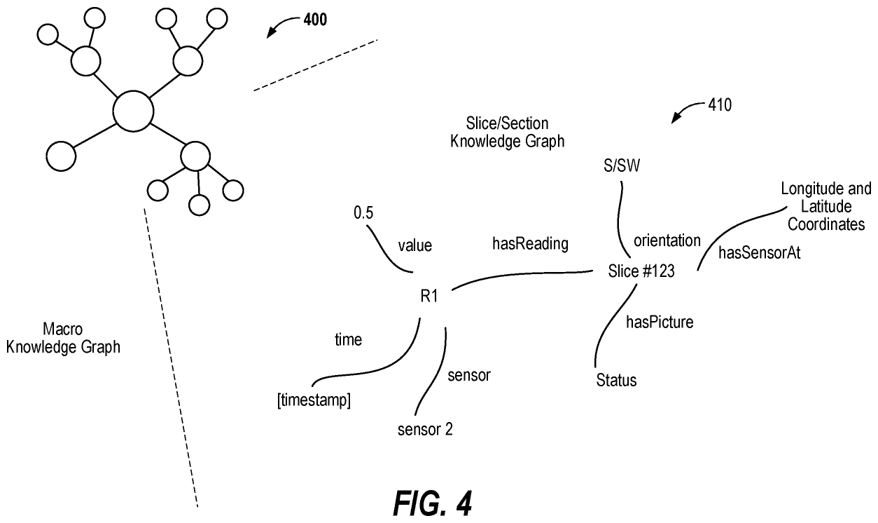

FIG. 4 depicts an example macro knowledge graph 400 extracted from data collected from sensor devices positioned to monitor an area of a complex system. The portion 410 of the macro knowledge graph 400 represents the collected and categorized data for a grid section of the monitored area. In the example depicted in FIG. 4, concepts corresponding to the data collected from the monitored area are provided as nodes, and relationships between concepts are provided as edges. Example concepts include components (e.g., a slice or grid section identifier, sensor identifiers) and concepts (e.g., timestamp, reading value) extracted from the collected data and/or metadata. As depicted in FIG. 4, the knowledge graph portion 410 includes various concepts that are extracted and/or identified from collected information as nodes (e.g., reading 1, sensor 2, timestamp data, a measured value, and so forth). The relationships between the concepts are depicted as edges in the knowledge graph portion 410 (e.g., orientation, hasPicture, value, time, and so forth).

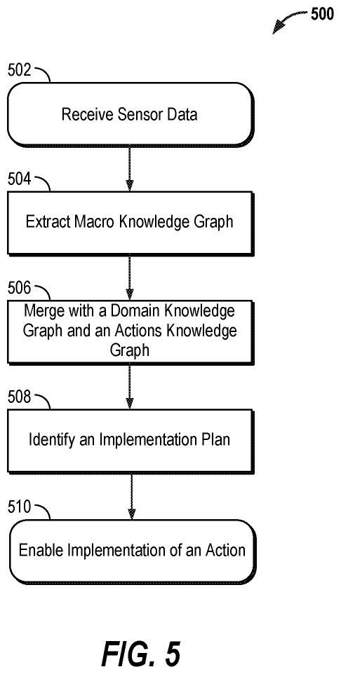

FIG. 5 depicts a flow diagram of an example process 500 that can be executed in implementations of the present disclosure. In some examples, the example process 500 is provided using one or more computer-executable programs executed by one or more computing devices (e.g., the back-end system 108 of FIG. 1). The example process 500 can be executed by an assessment system to enable an action to accomplish a goal for a monitored complex system, such as the bog 102 from FIG. 1.

At 502, a slicing policy is applied to an area within the complex system to divide the area based on an ordered grid. The ordered grid including a plurality of grid sections. In some implementations, the complex system is a peat bog and wherein the set goal is decontaminating soil content in an area within the peat bog. In some implementations, decontaminating the soil content includes reducing an amount of a chemical compound in the soil. In some implementations, the actions include placement a plant in a location in the peat bog to mitigate toxicity levels of the chemical compound. From 502, the process 500 processed to 504.

At 504, sensor data is received from a plurality of sensor devices positioned to collect readings from the complex system. In some implementations, the sensor data includes exogenous data regarding conditions occurring in and around the complex system. In some implementations, at least one of the sensor devices is included as a payload or component of a UAVs or a buoy deployed to an area around the complex system. In some implementations, the sensor data includes ambient air temperature data or ambient air pressure data. In some implementations, the sensor data includes information regarding soil and water content of the area within the peat bog. From 504, the process 500 proceeds to 506.

At 506, a knowledge graph for each of the grid sections is extracted based on the respective sensor data for each of the grid sections. From 506, the process 500 proceeds to 508.

At 508, a macro knowledge graph is extracted by linking the knowledge graph for each of the grid sections based on a relationship between each of the grid sections. The macro knowledge graph mapping elements of the complex system and causal relationships between the elements to represent a state of the complex system. From 508, the process 500 proceeds to 510.

At 510, the macro knowledge graph is merged with a domain knowledge graph and an actions knowledge graph to form a recommendation knowledge graph. The domain knowledge graph maps relevant expertise for the set goal in the complex system and the actions knowledge graph maps steps to achieve the set goal. In some the recommendations, the knowledge graph is formed by adding one or more nodes to the macro knowledge graph where a location of the one or more nodes being based on the domain knowledge graph. From 510, the process 500 proceeds to 512.

At 512, an implementation plan for accomplishing the set goal for the complex system is identified based on an analysis of the recommendation knowledge graph. The implementation plan including actions to accomplish the set goal for the complex system. From 512, the process 500 proceeds to 514.

At 514, an implementation of at least one of the actions in the implementation plan is enabled. From 514, the process 500 ends.

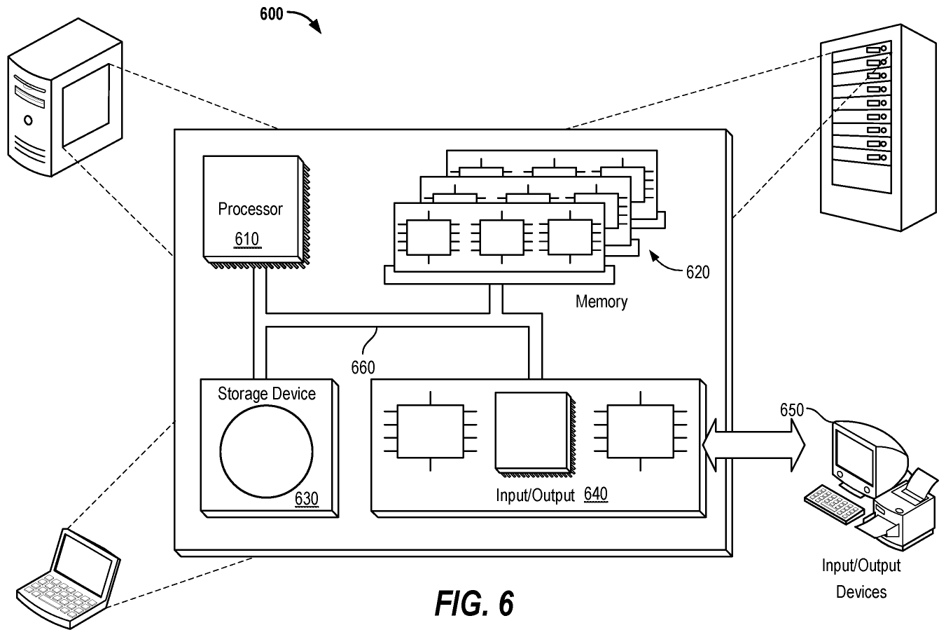

FIG. 6 depicts an example computing system 600 that can be employed in implementations of the present disclosure. Such a computing system 600 may be employed to provide, for example, a dashboard providing a view over the state of the complex system, a decision support tool processing the knowledge graph with respect to possible actions in order to guide on things to perform, or a data exchange system swapping knowledge graphs regarding different systems. The system 600 may be used for any of the operations described with respect to the various implementations discussed herein. For example, the system 600 may be included, at least in part, in one or more of the computing device(s) or system(s) described herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general-purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc, read-only memory (DVD-ROM) disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices, such as a display, light-emitting diodes (LEDs) display, an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the Institute of Electrical and Electronics Engineers (IEEE) 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to LANs, WANs, wireless WANs (WWANs), wireless LANs (WLANs), mobile communications networks (e.g., third generation (3G), fourth generations (4G), and Edge), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or a combination of one or more of them). A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, such as, a field programmable gate array (FPGA), an ASIC, or a graphics processing unit (GPU).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

To provide for interaction with a user, implementations may be realized on a computer having a display device, e.g., a cathode ray tube (CRT) or liquid crystal display (LCD) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a LAN and a WAN, e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method to enable implementations of actions to accomplish a set goal for a complex system, the method being executed by one or more processors and comprising:
applying a slicing policy to an area within the complex system to divide the area based on an ordered grid, the ordered grid including a plurality of grid sections;
receiving sensor data from a plurality of sensor devices positioned to collect readings from the complex system;
extracting a knowledge graph for each of the grid sections based on the respective sensor data for each of the grid sections;
extracting a macro knowledge graph by linking the knowledge graph for each of the grid sections based on a relationship between each of the grid sections, the macro knowledge graph mapping elements of the complex system and causal relationships between the elements to represent a state of the complex system;
merging the macro knowledge graph with a domain knowledge graph and an actions knowledge graph to form a recommendation knowledge graph; wherein the domain knowledge graph maps relevant expertise for the set goal in the complex system; wherein the actions knowledge graph maps steps to achieve the set goal;
identifying an implementation plan for accomplishing the set goal for the complex system based on an analysis of the recommendation knowledge graph, the implementation plan including actions to accomplish the set goal for the complex system; and
enabling an implementation of at least one of the actions in the implementation plan.

2. The method of claim 1, wherein the sensor data includes exogenous data regarding conditions occurring in and around the complex system.

3. The method of claim 1, wherein at least one of the sensor devices is included as a payload or component of an unmanned aerial vehicle (UAVs) or a buoy deployed to an area around the complex system.

4. The method of claim 1, wherein the recommendation knowledge graph is formed by adding one or more nodes to the macro knowledge graph, a location of the one or more nodes being based on the domain knowledge graph.

5. The method of claim 1, wherein the sensor data includes ambient air temperature data or ambient air pressure data.

6. The method of claim 1, wherein the complex system is a peat bog and wherein the set goal is decontaminating soil content in an area within the peat bog.

7. The method of claim 6, wherein the sensor data includes information regarding soil and water content of the area within the peat bog.

8. The method of claim 6, wherein decontaminating the soil content includes reducing an amount of a chemical compound in the soil.

9. The method of claim 8, wherein the actions include placement of a mirror in a location in the peat bog to increase sunlight to the area within the peat bog.

10. The method of claim 8, wherein the actions include placement a plant in a location in the peat bog to mitigate toxicity levels of the chemical compound.

11. One or more non-transitory computer-readable storage media coupled to one or more processors and having instructions stored thereon which, when executed by the one or more processors, cause the one or more processors to perform operations comprising:
applying a slicing policy to an area within a complex system to divide the area based on an ordered grid, the ordered grid including a plurality of grid sections;
receiving sensor data from a plurality of sensor devices positioned to collect readings from the complex system;
extracting a knowledge graph for each of the grid sections based on the respective sensor data for each of the grid sections;
extracting a macro knowledge graph by linking the knowledge graph for each of the grid sections based on a relationship between each of the grid sections, the macro knowledge graph mapping elements of the complex system and causal relationships between the elements to represent a state of the complex system;
merging the macro knowledge graph with a domain knowledge graph and an actions knowledge graph to form a recommendation knowledge graph; wherein the domain knowledge graph maps relevant expertise for a set goal in the complex system; wherein the actions knowledge graph maps steps to achieve the set goal;
identifying an implementation plan for accomplishing the set goal for the complex system based on an analysis of the recommendation knowledge graph, the implementation plan including actions to accomplish the set goal for the complex system; and
enabling an implementation of at least one of the actions in the implementation plan.

12. The one or more non-transitory computer-readable storage media of claim 11, wherein the sensor data includes exogenous data regarding conditions occurring in and around the complex system.

13. The one or more non-transitory computer-readable storage media of claim 11, wherein at least one of the sensor devices is included as a payload or component of an unmanned aerial vehicle (UAVs) or a buoy deployed to an area around the complex system.

14. The one or more non-transitory computer-readable storage media of claim 11, wherein the recommendation knowledge graph is formed by adding one or more nodes to the macro knowledge graph, a location of the one or more nodes being based on the domain knowledge graph.

15. A computer-implemented system, comprising:
one or more sensor devices positioned to collect readings from a complex system;
one or more processors; and
a computer-readable storage device coupled to the one or more processors and having instructions stored thereon which, when executed by the one or more processors, cause the one or more processors to perform operations comprising:
applying a slicing policy to an area within the complex system to divide the area based on an ordered grid, the ordered grid including a plurality of grid sections;
receiving sensor data from the one or more sensor devices;
extracting a knowledge graph for each of the grid sections based on the respective sensor data for each of the grid sections;
extracting a macro knowledge graph by linking the knowledge graph for each of the grid sections based on a relationship between each of the grid sections, the macro knowledge graph mapping elements of the complex system and causal relationships between the elements to represent a state of the complex system;
merging the macro knowledge graph with a domain knowledge graph and an actions knowledge graph to form a recommendation knowledge graph; wherein the domain knowledge graph maps relevant expertise for a set goal in the complex system; wherein the actions knowledge graph maps steps to achieve the set goal;
identifying an implementation plan for accomplishing the set goal for the complex system based on an analysis of the recommendation knowledge graph, the implementation plan including actions to accomplish the set goal for the complex system; and
enabling an implementation of at least one of the actions in the implementation plan.

16. The computer-implemented system of claim 15, wherein the complex system is a peat bog and wherein the set goal is decontaminating soil content in an area within the peat bog.

17. The computer-implemented system of claim 16 wherein the sensor data includes information regarding soil and water content of the area within the peat bog.

18. The computer-implemented system of claim 16, wherein decontaminating the soil content includes reducing an amount of a chemical compound in the soil.

19. The computer-implemented system of claim 18, wherein the actions include placement of a mirror in a location in the peat bog to increase sunlight to the area within the peat bog.

20. The computer-implemented system of claim 18, wherein the actions include placement a plant in a location in the peat bog to mitigate toxicity levels of the chemical compound.
